(19) United States
(12) Patent Application Publication
(10) Pub. No.: US 2025/0291338 A1
(43) Pub. Date: Sep. 18, 2025

(54) LASER MANAGEMENT SERVER AND LASER MANAGEMENT METHOD

(71) Applicant: Gigaphoton Inc., Tochigi (JP)

(72) Inventors: Yuji MINEGISHI, Oyama-shi (JP); Jacob Peter STROCK, Beaverton, OR (US)

(73) Assignee: Gigaphoton Inc., Tochigi (JP)

(21) Appl. No.: 19/045,015

(22) Filed: Feb. 4, 2025

Related U.S. Application Data
(60) Provisional application No. 63/565,708, filed on Mar. 15, 2024.

(51) Int. Cl. G05B 19/418; G06F 16/3332

(52) U.S. Cl. CPC G05B 19/41835; G06F 16/3338

(57) ABSTRACT

A laser management server for a laser device includes a sending and receiving processor receiving a query from outside; a query input processor receiving and decomposing the query, and generating a first query item requiring external information and a second query item without requiring external information; an agent action processor receiving the first query item, acquiring the required external information from unstructured data and structured data, and generating a first agent response; an equipment agent processor receiving the second query item, receiving the first agent response, and generating a query item prompt related to the second query item; a large language model processor receiving the query item prompt, and generating a query item response; and an equipment control processor receiving a first control signal, and transmitting the first control signal to the laser device. The equipment agent processor receives the query item response and generate the first control signal.

### CROSS-REFERENCE TO RELATED APPLICATIONS

The present application claims the benefit of U.S. Patent Application No. 63/565,708, filed on Mar. 15, 2024, the entire contents of which are hereby incorporated by reference.

### BACKGROUND

### 1. Technical Field

The present disclosure relates to a laser management server and a laser management method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 to 400 μm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be narrowed to the extent that the chromatic aberration can be ignored. For this purpose, there is a case in which a line narrowing module (LNM) including a line narrowing element (etalon, grating, and the like) is provided in a laser resonator of the gas laser device to narrow a spectral line width. In the following, a gas laser device with a narrowed spectral line width is referred to as a line narrowing gas laser device.

### LIST OF DOCUMENTS

### Patent Documents

Patent Document 1: International Publication No. WO2019/240906
Patent Document 2: Japanese Patent Application Publication No. 2006-24765
Patent Document 3: International Publication No. WO2020/161865

### SUMMARY

A laser management server for a laser device according to an aspect of the present disclosure includes a sending and receiving processor configured to receive a query from outside; a query input processor configured to receive the query from the sending and receiving processor, decompose the query, and generate a first query item that requires external information and a second query item that does not require external information; an agent action processor configured to receive the first query item from the query input processor, acquire the required external information from unstructured data including a manual and a maintenance report of the laser device and structured data including operation data of the laser device and at least one of a prediction result of lifetime of a consumable of the laser device by a lifetime prediction model and a prediction result of laser performance of the laser device by a laser performance prediction model, and generate a first agent response that is a response to the first query item; an equipment agent processor configured to receive the second query item from the query input processor, receive the first agent response from the agent action processor, and generate a query item prompt related to the second query item; a large language model processor configured to receive the query item prompt from the equipment agent processor, and generate a query item response that is a response to the query item prompt; and an equipment control processor configured to receive a first control signal for controlling the laser device from the equipment agent processor and transmit the first control signal to the laser device. Here, the equipment agent processor is configured to receive the query item response from the large language model processor, and generate the first control signal based on the first agent response and the query item response.

A laser management method for a laser device according to an aspect of the present disclosure includes a first step, to be performed by a sending and receiving processor, of receiving a query from outside; a second step, to be performed by a query input processor, of decomposing the query and generating a first query item that requires external information and a second query item that does not require external information; a third step, to be performed by an agent action processor, of receiving the first query item from the query input processor, acquiring the required external information from unstructured data including a manual and maintenance report of the laser device and structured data including operation data of the laser device and at least one of a prediction result of lifetime of a consumable of the laser device by a lifetime prediction model and a prediction result of laser performance of the laser device by a laser performance prediction model, and generating a first agent response that is a response to the first query item; a fourth step, to be performed by an equipment agent processor, of receiving the second query item from the query input processor, receiving the first agent response from the agent action processor, and generating a query item prompt related to the second query item; a fifth step, to be performed by a large language model processor, of receiving the query item prompt from the equipment agent processor, and generating a query item response that is a response to the query item prompt; a sixth step, to be performed by the equipment agent processor, of receiving the query item response from the large language model processor, and generating a first control signal for controlling the laser device based on the first agent response and the query item response; and a seventh step, to be performed by an equipment control processor, of receiving the first control signal from the equipment agent processor, and transmitting the first control signal to the laser device.

### BRIEF DESCRIPTION OF THE DRAWINGS

Embodiments of the present disclosure will be described below merely as examples with reference to the accompanying drawings.

FIG. 1 is a view showing the configuration of an exemplary laser device.

FIG. 2 is a diagram showing the configuration of a laser management system according to a comparative example.

FIG. 3 is a diagram showing the laser management system according to a first embodiment.

FIG. 4 is a diagram showing operation flow of the laser management system according to the first embodiment.

FIG. 5 is a table showing an example of query items generated from a query of a user according to the first embodiment.

FIG. 6 is a flowchart showing a control example of the laser device with a laser management server according to the first embodiment.

FIG. 7 is a diagram showing the configuration of the laser management system according to a modification of the first embodiment.

FIG. 8 is a diagram showing operation flow of the laser management system according to the modification of the first embodiment.

FIG. 9 is a flowchart showing a control example of the laser device with the laser management server according to a second embodiment.

### DESCRIPTION OF EMBODIMENTS

### <Contents>

1. Description of terms
2. Comparative example
   2.1 Laser device
      2.1.1 Configuration
      2.1.2 Operation
   2.2 Laser management system
      2.2.1 Configuration
      2.2.2 Operation
      2.2.3 Problem
3. First Embodiment
   3.1 Configuration
   3.2 Operation
      3.2.1 Operation flow of laser management system
      3.2.2 Control flow of laser device
   3.3 Effect
4. Modification of first embodiment
   4.1 Configuration
   4.2 Operation
   4.3 Effect
5. Second Embodiment
   5.1 Configuration
   5.2 Operation
   5.3 Effect
6. Others

The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Description of Terms

Terms used in the present specification are defined as follows.

“Standard software” is application software that performs at least one task of management, monitoring, and analysis of a particular device based on predefined functions and display specifications.

A “web application” is application software that is available on the Internet using a web browser. The web application can be used on various terminals such as a personal computer, a smartphone, a tablet, and the like, as long as it is connected to the Internet, without installing application software.

A “standard operation screen” is a standard user interface (UI) of application software designed in advance.

An “interactive operation screen” is an operation screen in which a user issues questions and commands in a natural language, and application software responds to the questions and the commands from the user.

“Unstructured data” is data that has neither regularity nor continuity, and is in a format that is difficult to manage in a normal database or table. The unstructured data is, for example, a text document, an image, an audio file, or the like.

“Operation data” is information generated through operation of a laser device.

A “specialized information processing processor” is a chat agent having a high level of expertise for a specific field. Unlike a general chat agent, the specialized information processing processor can accurately respond to dialogs related to terms and concepts in a field of specialization.

A “query” is an inquiry or an instruction that the entire system receives from a user. The query is an instruction character string configured by a natural language that designates information to be acquired and a provision format of the information, or designates operation to be performed by the laser device. The query is, for example, “Report a detail operation diagnosis of the laser 65400011 in a standard format.”

A “query response” is a result configured by a natural language returned by the system in response to a specific query. The query response includes not only a character string, but also a graph, an image, or the like depending on the content.

A “large language model processor (LLM)” performs processing by an artificial intelligence (AI) model trained using a large amount of text data in natural language processing. The large language model processor understands and performs complex language tasks.

A “prompt” is an instruction or a question in a natural language text transmitted to the LLM. The prompt causes the LLM to understand what to respond to or what task to perform.

A “query input processor (QIP)” performs a process of analyzing a user's request (query) and replacing the query with an appropriate input prompt for the LLM.

A “response output processor (ROP)” performs a process of configuring a content to be returned as an answer response of the LLM into a format and a content according to the content designated by a user.

An “agent action processor (AAP)” analyzes an output of the LLM, acquires information required to form an appropriate response from an external information source, and performs a process of assembling an appropriate response that matches a user's query.

### 2. Comparative Example

### 2.1 Laser Device

### 2.1.1 Configuration

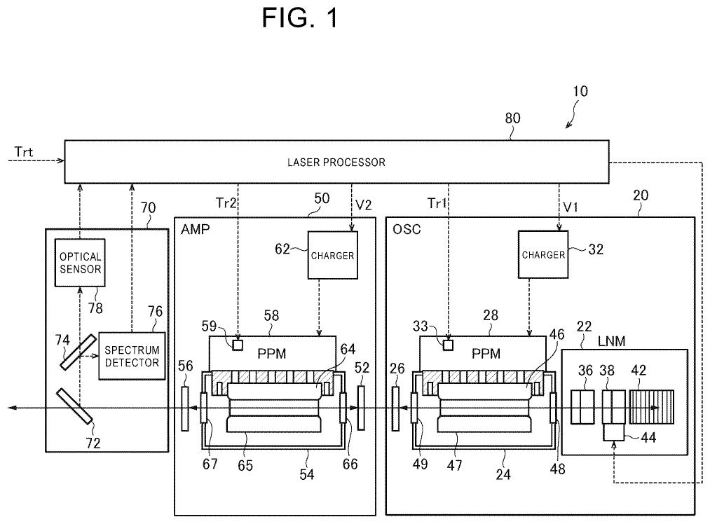

FIG. 1 is a view schematically showing the configuration of an exemplary laser device 10. The laser device 10 is a discharge-excitation-type gas laser device, and includes an oscillator (OSC) 20, an amplifier (AMP) 50, a monitor module 70, and a laser processor 80. The processor of the present disclosure is a processing device including a storage device in which a control program is stored and a CPU which performs the control program. The processor is specifically configured or programmed to perform various processes.

The OSC 20 includes a line narrowing module (LNM) 22, a chamber 24, an output coupler (OC) 26, a pulse power module (PPM) 28, and a charger 32.

The LNM 22 includes prisms 36, 38, a grating 42, and a rotation stage 44 that rotates the prism 38. The LNM 22 changes the incident angle on the grating 42 by rotating the prism 38 so that the center wavelength of pulse laser light is controlled.

The chamber 24 includes a pair of discharge electrodes 46, 47 and two windows 48, 49 through which laser light is transmitted. An excimer laser gas is introduced into the chamber 24.

The excimer laser gas includes, for example, a rare gas (an Ar gas or a Kr gas), a halogen gas (an F₂ gas), and a buffer gas (an Ne gas).

The OC 26 is a partial reflection mirror that reflects a part of the pulse laser light and transmits the other part.

The LNM 22 and the OC 26 configure an optical resonator together, and the chamber 24 is arranged on the optical path of the optical resonator.

The AMP 50 includes a rear mirror (RM) 52, a chamber 54, an output coupler (OC) 56, a pulse power module (PPM) 58, and a charger 62.

The RM 52 is a partial reflection mirror that reflects a part of the pulse laser light and transmits the other part. The reflectance of the RM 52 may be between 80% and 90%.

The chamber 54 includes a pair of discharge electrodes 64, 65 and two windows 66, 67 through which the laser light is transmitted. The excimer laser gas is introduced into the chamber 54.

The OC 56 is a partial reflection mirror that reflects a part of the pulse laser light and transmits the other part. The reflectance of the OC 56 may be between 10% and 30%.

The RM 52 and the OC 56 configure an optical resonator together, and the chamber 54 is arranged on the optical path of the optical resonator. The optical resonator may be a Fabry-Perot optical resonator.

The monitor module 70 includes beam splitters 72, 74, a spectrum detector 76 that measures the wavelength and the spectral line width of the pulse laser light, and an optical sensor 78 that detects the pulse energy of the pulse laser light. The spectrum detector 76 may be an etalon spectrometer. The optical sensor 78 may be a photodiode.

### 2.1.2 Operation

The laser processor 80 receives a target center wavelength λt and a target pulse energy Et from an external apparatus such as an exposure apparatus (not shown). Then, the laser processor 80 sets a charge voltage V1 of the charger 32 and a charge voltage V2 of the charger 62 such that the pulse laser light having the target pulse energy Et can be obtained.

A first charging capacitor (not shown) in the PPM 28 is charged with the charge voltage V1. A second charging capacitor (not shown) in the PPM 58 is charged with the charge voltage V2.

Upon receiving a light emission trigger Trt from the external apparatus such as the exposure apparatus, the laser processor 80 transmits a light emission trigger Tr1 to the switch 33 in the PPM 28. When the switch 33 is operated, charges charged in the first charging capacitor are converted into high voltage pulses in the PPM 28 in accordance with the charge voltage V1 and applied between the discharge electrodes 46, 47 in the chamber 24.

As a result, discharge occurs between the discharge electrodes 46, 47 in the chamber 24, and the laser gas is excited. Then, the light line-narrowed by the optical resonator configured of the OC 26 and the LNM 22 to an ultraviolet wavelength of 380 nm to 150 nm is output from the OSC 20 as seed light. The wavelength of the seed light may be an oscillation wavelength of the ArF excimer laser or an oscillation wavelength of the KrF excimer laser.

Further, upon receiving the light emission trigger Trt, the laser processor 80 transmits a light emission trigger Tr2 to the switch 59 of the PPM 58 so that discharge occurs between the discharge electrodes 64, 65 when the seed light output from the OSC 20 enters the discharge space of the chamber 54 of the AMP 50.

When the switch 59 is operated, charges charged in the second charging capacitor are converted into high voltage pulses in the PPM 58 in accordance with the charge voltage V2 and applied between the discharge electrodes 64, 65 in the chamber 54.

As a result, discharge occurs between the discharge electrodes 64, 65 in the chamber 54, and the laser gas is excited. At this timing, the seed light output from the OSC 20 is transmitted through the RM 52 and enters the discharge space in the chamber 54. The entering seed light is amplified by the optical resonator configured of the RM 52 and the OC 56, and is output from the AMP 50.

The pulse laser light output from the AMP 50 enters the monitor module 70. A part of the pulse laser light entering the monitor module 70 is reflected by the beam splitter 72, and a part of the reflected pulse laser light is further reflected by the beam splitter 74 and enters the spectrum detector 76. The pulse laser light transmitted through the beam splitter 74 enters the optical sensor 78.

The spectrum detector 76 measures the center wavelength of the pulse laser light. The optical sensor 78 measures the pulse energy of the pulse laser light.

The laser processor 80 may control the rotation stage 44 in the LNM 22 so that the center wavelength measured by the spectrum detector 76 becomes the target center wavelength λt. The rotation stage 44 may include a piezoelectric element.

The laser processor 80 may control the charge voltage V2 output from the charger 62 so that the pulse energy measured by the optical sensor 78 becomes the target pulse energy Et.

### 2.2 Laser Management System

### 2.2.1 Configuration

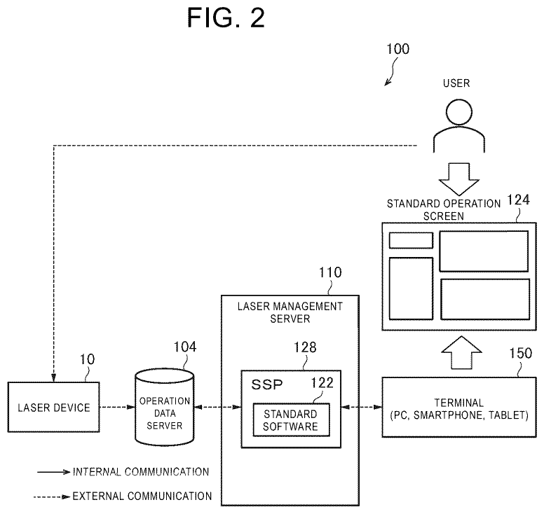

FIG. 2 is a diagram showing the configuration of a laser management system 100 according to a comparative example. The comparative example of the present disclosure is an example recognized by the applicant as known only by the applicant, and is not a publicly known example admitted by the applicant. The laser management system 100 performs at least one of management, monitoring, and analysis of the laser device 10.

The laser management system 100 includes the laser device 10, an operation data server 104, a laser management server 110, and a terminal 150.

The operation data server 104 is a data server in which operation data of the laser device 10 is stored.

The terminal 150 is, for example, a personal computer, a smartphone, a tablet, or the like.

The laser management server 110 includes a standard software processor (SSP) 128 in which standard software 122 is stored.

The SSP 128 acquires operation data of the laser device 10 from the operation data server 104 via a network.

The standard software 122 is provided in a form of a web application to be operated via the network.

A standard operation screen 124 of the standard software 122 is displayed on the terminal 150 so as to be operable by a user.

### 2.2.2 Operation

The laser device 10 transmits the operation data to the operation data server 104, and the operation data server 104 accumulates the operation data.

The laser management server 110 receives a request of viewing predetermined information or the like from the user through the standard operation screen 124.

The standard software 122 of the laser management server 110 performs analysis and the like of a predetermined laser device 10 using the accumulated operation data. The standard software 122 provides the user with at least one of the functions of management, monitoring, and analysis of the predetermined laser device 10.

The standard software 122 of the laser management server 110 displays requested information and the like on the standard operation screen 124.

The user views the information on the standard operation screen 124.

Different standard software 122 or a different standard operation screen 124 is provided to different users such as a field service engineer (FSE), a device owner, and a research-and-development engineer according to their respective applications.

### 2.2.3 Problem

When the FSE controls the laser device 10 such as changing a parameter, the operation data server 104 storing the operation data of the laser device 10 is accessed through the standard operation screen 124, and the operation data in the operation data server 104 is checked. Then, the FSE determines a control value or the like of the parameter change of the laser device 10. At this time, the FSE estimates transition of future laser property (laser performance) according to the number of pulses or the date and time and the future laser performance after the parameter change. Here, the laser characteristic is, for example, a pulse energy, a center wavelength, and a spectral line width of the pulse laser light output from the laser device 10, a gas pressure in a chamber, an application voltage between electrodes, and a used number of pulses of respective components. The laser performance may include an index related to the performance of the laser device 10.

However, even for an experienced FSE, it is difficult to estimate the future laser performance of the laser device 10.

Further, when a difference occurs in information acquired by the FSE, the control signal of the laser device 10 varies and is not stable.

### 3. First Embodiment

### 3.1 Configuration

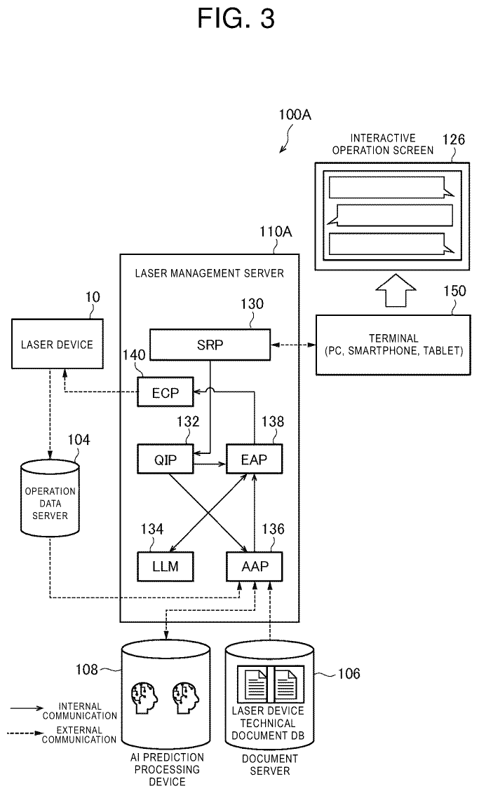

FIG. 3 is a diagram showing a laser management system 100A according to a first embodiment. The configuration shown in FIG. 3 will be described in terms of differences from the configuration shown in FIG. 2.

The laser management system 100A differs from the laser management system 100 in the configuration in the laser management server 110A, in that a document server 106 and an AI prediction processing device 108 are connected to the laser management server 110A, and that a control signal of the parameter change and the like are transmitted from the laser management server 110A to the laser device 10. Here, the term “management” in the present disclosure includes the concept of “control”.

The laser management server 110A includes a sending and receiving processor (SRP) 130, a query input processor (QIP)132, a large language model processor (LLM) 134, an agent action processor (AAP) 136, an equipment agent processor (EAP) 138, and an equipment control processor (ECP) 140.

The SRP 130, the QIP 132, the LLM 134, the AAP 136, the EAP 138, and the ECP 140 may be application software or hardware such as a CPU. Respective pieces of application software may be collectively implemented as a single processor.

Input and output by a user are performed on an interactive operation screen 126 on the terminal 150 through the SRP 130.

The SRP 130 performs input and output to and from the interactive operation screen 126 on the terminal 150.

The ECP 140 can communicate with the laser device 10.

The document server 106 stores unstructured data such as manuals and maintenance reports of the laser device 10. The document server 106 includes a laser device technical document database (DB).

The AI prediction processing device 108 includes at least either of a lifetime prediction model for predicting the lifetime of consumables of the laser device 10 and a laser performance prediction model for predicting the future laser performance of the laser device 10.

The lifetime prediction model may be, for example, a learned model created by a machine learning method described in Patent Document 3. The machine learning method described in Patent Document 3 is a machine learning method for creating a learning model for predicting the lifetime of a consumable of the laser device 10 and includes: acquiring first lifetime-related information including data of a lifetime-related parameter of the consumable recorded corresponding to the number of oscillation pulses during different time periods from the start of the use of the consumable to the replacement thereof; dividing the first lifetime-related information into a plurality of levels representing the deterioration degree of the consumable according to the number of oscillation pulses and creating training data in which the first lifetime-related information is associated with the level representing the deterioration degree; creating a learning model for predicting the deterioration degree of the consumable from the data of the lifetime-related parameter by performing machine learning using the training data; and storing the created learning model. The AI prediction processing device 108 can predict the lifetime of each of the consumables scheduled to be replaced by using a corresponding lifetime prediction model for the consumable scheduled to be replaced in the laser device 10 based on the lifetime-related information of the consumable.

Here, the learning model is, for example, a neural network model, and is, in substance, a program that causes the computer to perform a process of predicting the deterioration degree of the consumable of the laser device 10.

The AI prediction processing device 108 can predict the lifetime of each of the consumables scheduled to be replaced by using a corresponding lifetime prediction model for the consumable scheduled to be replaced in the laser device 10 based on the lifetime-related information of the consumable.

The laser performance prediction model is a learned model capable of predicting onward transition of the laser performance of the laser device 10 according to the number of pulses or the date and time in an arbitrary component replacement scenario.

At least one of the operation data server 104 and the document server 106 may be implemented in the laser management server 110A.

The terminal 150 may be connected to the laser management server 110A via a network, or may be connected via a wired cable or wirelessly.

The interactive operation screen 126 on the terminal 150 may be displayed on a monitor screen of the laser management server 110A.

Other configurations may be similar to those in FIG. 2.

### 3.2 Operation

### 3.2.1 Operation Flow of Laser Management System

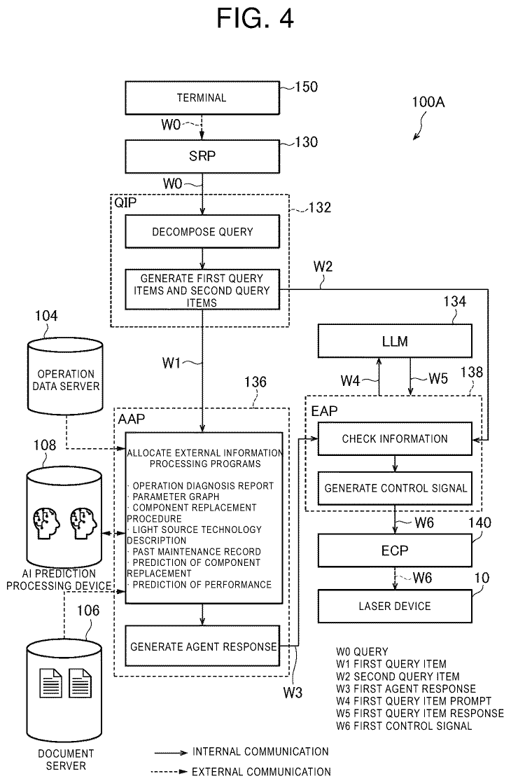

FIG. 4 is a diagram showing operation flow of the laser management system 100A according to the first embodiment. The operation flow of the laser management system 100A will be described with reference to FIG. 4.

The SRP 130 receives a query W0 from the terminal 150.

The QIP 132 decomposes the query W0 received from the SRP 130, and generates first query items W1 that require external information and second query items W2 that do not require external information.

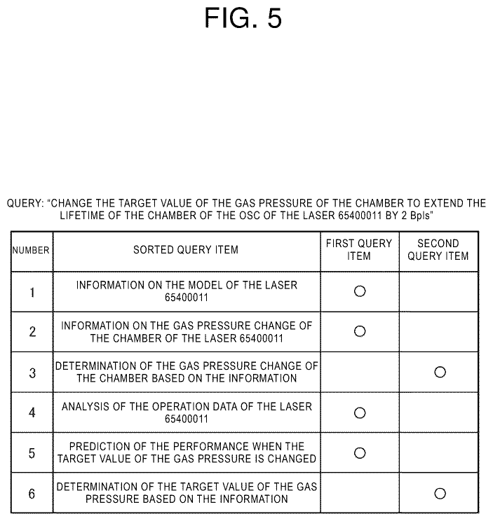

FIG. 5 is a table showing an example of query items generated from a query of a user. FIG. 5 shows a generation example of the first query items W1 and the second query items W2 when the query W0 is “Change the target value of the gas pressure of the chamber to extend the lifetime of the chamber of the OSC of the laser 65400011 by 2 Bpls.” Here, “laser 65400011” is a name for identifying a type (model) of the laser.

In this case, the QIP 132 decomposes the received query W0 into six query items. The query item of item number 1 is “Information on the model of the laser 65400011”, the query item of item number 2 is “Information on the gas pressure change of the chamber of the laser 65400011”, the query item of item number 3 is “Determination of the gas pressure change of the chamber based on the information”, the query item of item number 4 is “Analysis of the operation data of the laser 65400011”, the query item of item number 5 is “Prediction of the performance when the target value of the gas pressure is changed”, and the query item of item number 6 is “Determination of the target value of the gas pressure based on the information”.

Among these six query items, the query items of item numbers 1, 2, 4, and 5 are classified into the first query items W1 because it is difficult to obtain an appropriate answer by the LLM 134 alone and external information is required to obtain an appropriate answer. The query items of item numbers 3 and 6 do not require external information for answering, and are classified into the second query items W2.

Here, the external information refers to information existing in at least one of the operation data server 104, the document server 106, and the AI prediction processing device 108. The criterion for determining whether or not the query item requires external information is, for example, whether or not a response with high accuracy can be generated by the LLM 134 alone. For query items classified into the first query items W1, it is difficult to generate a response with high accuracy by the LLM 134 alone. For query items classified into the second query items W2, a response with high accuracy can be generated by the LLM 134 alone. A response with high accuracy refers to a response that is based on facts and has less false recognition and error.

Here, depending on the content of the query W0 received from the SRP 130, only either the first query items W1 or the second query items W2 may be generated.

The QIP 132 transmits the second query items W2 to the EAP 138.

The QIP 132 transmits the first query items W1 to the AAP 136. Further, the first query items W1 may also be transmitted to the EAP 138 for use in checking external information.

The AAP 136 receives the first query items W1 from the QIP 132 and allocates a corresponding external information processing program for each of the first query items W1. The external information processing program acquires required information from the outside (at least one of the operation data server 104, the document server 106, and the AI predicting processing processor 108), analyzes the acquired information, and summarizes the result.

For example, for the first query item W1 of item number 2 of FIG. 5, the AAP 136 acquires and analyzes the manual of the laser 65400011 from the document server 106 and summarizes the result. For the first query item W1 of item number 4 of FIG. 5, the AAP 136 acquires, from the operation data server 104, an application voltage (HV) between the discharge electrodes 46, 47 in the chamber 24 of the OSC 20 of the laser 65400011, a gas pressure in the chamber 24 of the OSC 20, and a total number of shots of the device, analyzes the data, and summarizes the result. For the first query item W1 of item number 5 of FIG. 5, the AAP 136 acquires the operation data of the laser 65400011 from the operation data server 104 and transmits the acquired operation data to the AI prediction processing device 108, the laser performance prediction model of the AI prediction processing device 108 acquires, based on the operation data, the prediction results of the laser performance such as the application voltage (HV) between the discharge electrodes 46, 47 and the gas pressure in the chamber 24 of the OSC 20 when the target value of the gas pressure in the chamber 24 of the OSC 20 is changed, the acquired results are analyzed, and the results are summarized.

The AAP 136 performs all of the allocated external information processing programs. The AAP 136 performs an external information configuration process to summarize all of the information, and generates a first agent response W3. At this time, the AAP 136 performs processing while communicating with the LLM 134 as necessary.

The AAP 136 transmits the first agent response W3 to the EAP 138.

The EAP 138 receives the second query items W2 from the QIP 132 and receives the first agent response W3 from the AAP 136.

The EAP 138 may receive the first agent response W3 from the AAP 136 and check whether or not required information is included.

The EAP 138 generates a first query item prompt W4 related to a response to the second query items W2. The first query item prompt W4 related to the second query item W2 of item number 3 of FIG. 5 includes, for example, the manual of the laser device 10 and a prompt of “Teach how to change the target value of the gas pressure of the chamber of the OSC of the laser 65400011.”

The LLM 134 receives the first query item prompt W4 from the EAP 138 and generates a first query item response W5 that is a response to the first query item prompt W4. The first query item response W5 to the first query item prompt W4 of the second query item W2 of item number 3 of FIG. 5 is, for example, “How to change the target value of the gas pressure of the chamber of the OSC of the laser 65400011.”

The EAP 138 generates a first control signal W6 of the laser device 10 based on the first query item response W5 and the first agent response W3. The first control signal W6 is, for example, a control signal having the meaning of “Change the target value of the gas pressure of the chamber of the OSC from P1 to P2.”

The EAP 138 transmits the generated first control signal W6 to the ECP 140.

The ECP 140 receives the first control signal W6 from the EAP 138 and transmits the first control signal W6 to the laser device 10.

### 3.2.2 Control Flow of Laser Device

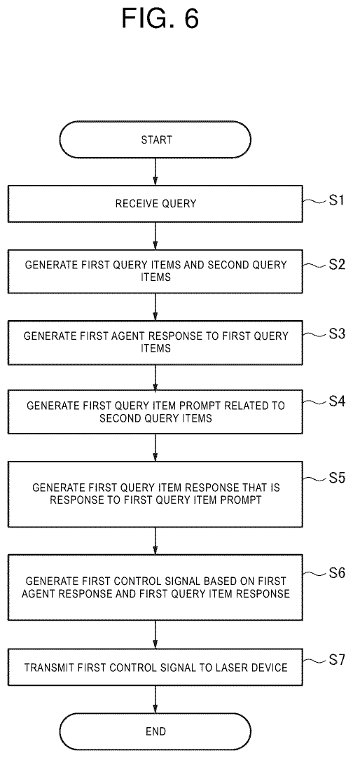

FIG. 6 is a flowchart showing a control example of the laser device 10 with the laser management server 110A according to the first embodiment. The method including steps S1 to S7 shown in FIG. 6 is an example of the “laser management method” in the present disclosure.

In step S1, the SRP 130 receives the query W0 from the outside. Step S1 is an example of the “first step” in the present disclosure.

In step S2, the QIP 132 decomposes the query W0, and generates the first query items W1 that require external information and the second query items W2 that do not require external information. Step S2 is an example of the “second step” in the present disclosure.

In step S3, the AAP 136 receives the first query items W1 from the QIP 132, acquires required information from the unstructured data including the manuals and the maintenance reports of the laser device 10 and structured data including the operation data of the laser device 10 and at least one of the prediction result of the lifetime of a consumable of the laser device 10 by the lifetime prediction model and the prediction result of the laser performance of the laser device 10 by the laser performance prediction model, and generates the first agent response W3 that is a response to the first query item W1. Step S3 is an example of the “third step” in the present disclosure.

In step S4, the EAP 138 receives the second query items W2 from the QIP 132, receives the first agent response W3 from the AAP 136, and generates the first query item prompt W4 related to the second query item W2. Step S4 is an example of the “fourth step” in the present disclosure.

In step S5, the LLM 134 receives the first query item prompt W4 from the EAP 138 and generates the first query item response W5 that is a response to the first query item prompt W4. Step S5 is an example of the “fifth step” in the present disclosure.

In step S6, the EAP 138 receives the first query item response W5 from the LLM 134 and generates the first control signal W6 for controlling the laser device 10 based on the first agent response W3 and the first query item response W5. Step S6 is an example of the “sixth step” in the present disclosure.

In step S7, the ECP 140 receives the first control signal W6 from the EAP 138 and transmits the first control signal W6 to the laser device 10. Step S7 is an example of the “seventh step” in the present disclosure.

### 3.3 Effect

According to the laser management system 100A, onward transition of the laser performance of the laser device 10 can be predicted by the laser performance prediction model. Therefore, the FSE can easily estimate the future laser performance of the laser device 10.

In the laser management system 100A, the QIP 132 decomposes the query W0 and generates the first query items W1 that require external information and the second query items W2 that do not require external information. Then, in the laser management system 100A, the AAP 136 acquires the required external information, and the EAP 138 generates the first control signal W6 of the laser device 10 based on the acquired external information. Therefore, the laser management system 100A can stably acquire valid information and also stabilize the control of the laser device 10.

### 4. Modification of First Embodiment

### 4.1 Configuration

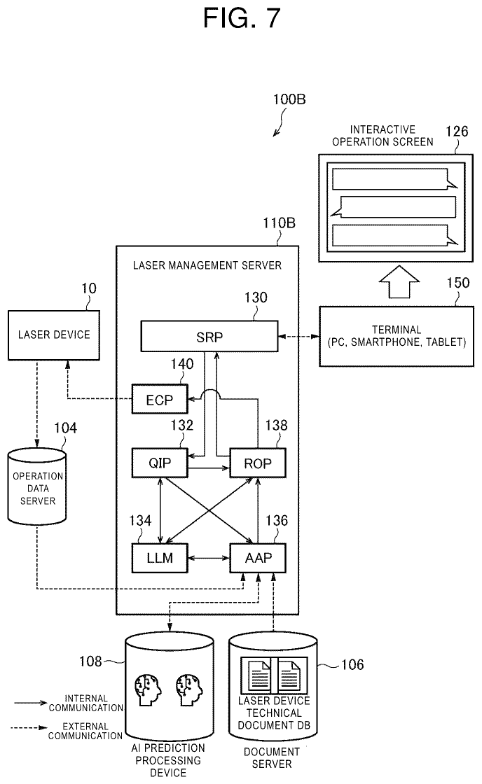

FIG. 7 is a diagram showing the configuration of a laser management system 100B according to a modification of the first embodiment. The configuration shown in FIG. 7 will be described in terms of differences from the configuration shown in FIG. 3.

The laser management system 100B differs from the laser management system 100A in that communication is performed between the QIP 132 and the LLM 134, between the AAP 136 and the LLM 134, and between the EAP 138 and the SRP 130. Other configurations may be similar to those of the laser management system 100A shown in FIG. 3.

### 4.2 Operation

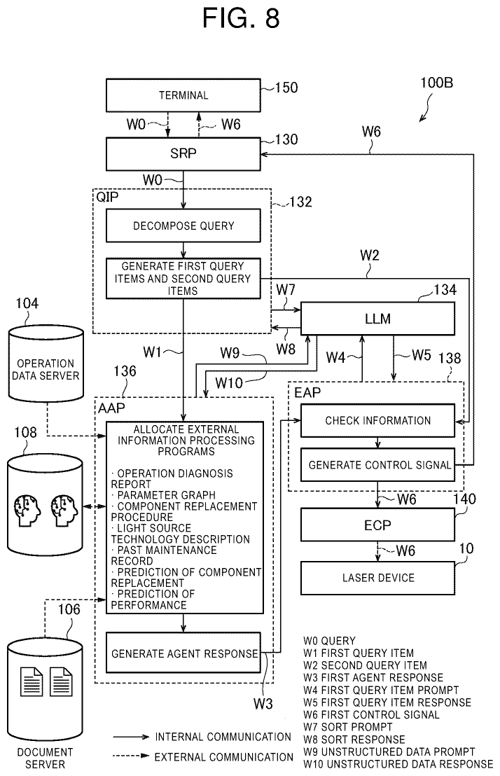

FIG. 8 is a diagram showing operation flow of the laser management system 100B. The operation flow of the laser management system 100B shown in FIG. 8 will be described in terms will differences from that shown in FIG. 4.

The QIP 132 may generate a sort prompt W7 when performing language processing in the generation of the first query items W1 and the second query items W2. The sort prompt W7 is, for example, “Decompose the query into items.”

The LLM 134 may receive the sort prompt W7 from the QIP 132 and generate a sort response W8 that is a response to the sort prompt W7. The sort response W8 is, for example, query items divided into items as shown in FIG. 5.

The QIP 132 may receive the sort response W8 from the LLM 134.

The AAP 136 may generate an unstructured data prompt W9 when acquiring unstructured data and generating the first agent response W3. The unstructured data prompt W9 includes, for example, external information of the manual of the laser device 10 and a prompt of “Tell me where the method of changing the target value of the gas pressure of the chamber of the OSC of the laser 65400011 is described.”

The LLM 134 may receive the unstructured data prompt W9 from the AAP 136 and generate an unstructured data response W10 that is a response to the unstructured data prompt W9. The unstructured data response W10 is, for example, “The method of changing the gas pressure of the chamber of the OSC of the laser 65400011 is described in line BB of page AA to line DD of page CC.”

The AAP 136 may receive the unstructured data response W10 from the LLM 134. The AAP 136 analyzes the unstructured data response W10 received from the LLM 134 and generates the first agent response W3. In this case, the AAP 136 allocates an appropriate external information processing program and generates the first agent response W3 from the allocation result.

The EAP 138 may transmit the first control signal W6 to the SRP 130.

The SRP 130 may transmit the first control signal W6 received from the EAP 138 to the terminal 150. The first control signal W6 is displayed on the interactive operation screen 126 on the terminal 150.

The EAP 138 may transmit the first agent response W3 or the first query item response W5 to the SRP 130. The EAP 138 may configure a query response based on the first agent response W3 and the first query item response W5, and transmit the configured query response to the SRP 130. The EAP 138 may generate the query response by combining the first agent response W3 that is a generation result of the AAP 136 and the first query item response W5 that is a generation result of the LLM 134. The SRP 130 may transmit at least one of the first agent response W3 received from the EAP 138, the first query item response W5, and the query response to the terminal 150. At least one of the first agent response W3, the first query item response W5, and the query response may be displayed on the interactive operation screen 126 on the terminal 150.

The interactive operation screen 126 on the terminal 150 may display a message to a user. The message may include a comment on at least one of the first control signal W6, the first agent response W3, the first query item response W5, and the query response. Here, the comment may include a figure, a table, or the like. The laser management system 100B may generate at least one of the first control signal W6, the first agent response W3, the first query item response W5, and the query response corresponding to the content of the query W0. The content of the query W0 is intended for at least one of the functions of management, monitoring, and analysis.

Other operation may be similar to that in FIG. 4.

### 4.3 Effect

According to the laser management system 100B, effects similar to those of the laser management server 110A can be obtained.

According to the laser management system 100B, the language processing function is further improved in both of the QIP 132 and the AAP 136 as compared with the laser management system 100A.

### 5. Second Embodiment

### 5.1 Configuration

The configuration of a laser management system according to a second embodiment may be similar to the configuration of the laser management system 100B.

### 5.2 Operation

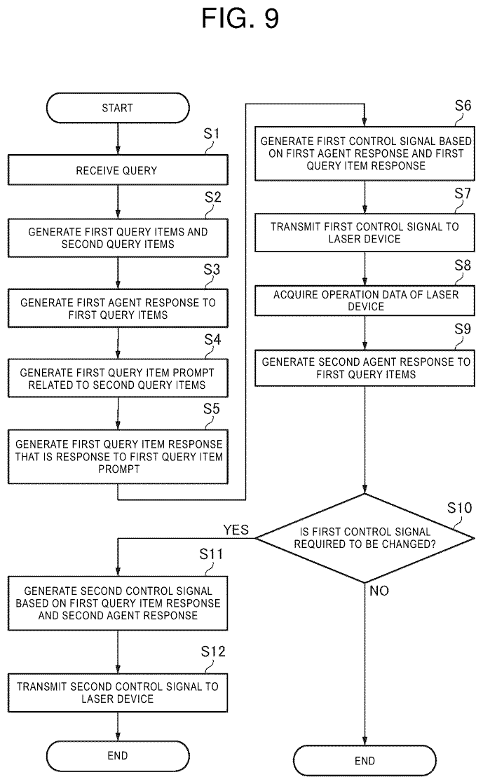

FIG. 9 is a flowchart showing a control example of the laser device 10 with a laser management server according to the second embodiment. FIG. 9 will be described in terms of differences from FIG. 6. In FIG. 9, steps S8 to S12 are added after step S7.

After a predetermined time elapses after step S7, in step S8, the AAP 136 acquires the operation data of the laser device 10 after transmitting the first control signal W6. The operation data of the laser device 10 is stored in the operation data server 104. Step S8 is an example of the “eighth step” in the present disclosure.

In step S9, the AAP 136 generates a second agent response that is a response to the first query items W1. Step S9 is an example of the “ninth step” in the present disclosure. The AAP 136 may analyze the operation data of the laser device 10 to generate the second agent response to the first query items W1. The second agent response may also be different from the first agent response W3.

In step S10, the EAP 138 receives the second agent response from the AAP 136 and determines whether or not the first control signal W6 is required to be changed based on the second agent response. When the determination of step S10 is “YES”, processing proceeds to step S11. When the determination of step S10 is “NO”, processing ends. Step S10 is an example of the “tenth step” in the present disclosure.

In step S11, the EAP 138 generates a second control signal for controlling the laser device 10 based on the first query item response W5 and the second agent response. Step S11 is an example of the “eleventh step” in the present disclosure.

In step S12, the ECP 140 receives the second control signal from the EAP 138 and transmits the second control signal to the laser device 10. Step S12 is an example of the “twelfth step” in the present disclosure.

The control flow of steps S8 to S12 may be repeated a plurality of times.

Other steps may be similar to those in FIG. 6.

### 5.3 Effect

According to the laser management system of the second embodiment, effects similar to those of the laser management server 110A and the laser management system 100B can be obtained.

In the laser management system according to the second embodiment, since the operation data of the laser device 10 after transmitting the first control signal W6 is acquired and the second control signal is generated as necessary, the control of the laser device 10 is further stabilized.

### 6. Others

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A laser management server for a laser device, comprising:
a sending and receiving processor configured to receive a query from outside;
a query input processor configured to receive the query from the sending and receiving processor, decompose the query, and generate a first query item that requires external information and a second query item that does not require external information;
an agent action processor configured to receive the first query item from the query input processor, acquire the required external information from unstructured data including a manual and a maintenance report of the laser device and structured data including operation data of the laser device and at least one of a prediction result of lifetime of a consumable of the laser device by a lifetime prediction model and a prediction result of laser performance of the laser device by a laser performance prediction model, and generate a first agent response that is a response to the first query item;
an equipment agent processor configured to receive the second query item from the query input processor, receive the first agent response from the agent action processor, and generate a query item prompt related to the second query item;
a large language model processor configured to receive the query item prompt from the equipment agent processor, and generate a query item response that is a response to the query item prompt; and
an equipment control processor configured to receive a first control signal for controlling the laser device from the equipment agent processor, and transmit the first control signal to the laser device,
the equipment agent processor being configured to receive the query item response from the large language model processor, and generate the first control signal based on the first agent response and the query item response.

2. The laser management server according to claim 1,
wherein the agent action processor acquires the operation data of the laser device after transmitting the first control signal and generates a second agent response that is a response to the first query item,
the equipment agent processor receives the second agent response from the agent action processor, determines whether or not the first control signal is required to be changed based on the second agent response, and generates, when it is determined that the first control signal is required to be changed, a second control signal for controlling the laser device based on the query item response and the second agent response, and
the equipment control processor receives the second control signal from the equipment agent processor and transmits the second control signal to the laser device.

3. The laser management server according to claim 1,
wherein the query input processor generates a sort prompt when performing language processing in the generation of the first query item and the second query item,
the large language model processor receives the sort prompt from the query input processor, and generates a sort response that is a response to the sort prompt, and
the query input processor receives the sort response from the large language model processor.

4. The laser management server according to claim 1,
wherein the agent action processor generates an unstructured data prompt when acquiring the unstructured data and generating the first agent response,
the large language model processor receives the unstructured data prompt from the agent action processor, and generates an unstructured data response that is a response to the unstructured data prompt, and
the agent action processor receives the unstructured data response from the large language model processor.

5. The laser management server according to claim 4,
wherein the unstructured data prompt includes the unstructured data.

6. The laser management server according to claim 1,
wherein the equipment agent processor transmits the first control signal to the sending and receiving processor.

7. The laser management server according to claim 1,
wherein the sending and receiving processor receives the first control signal from the equipment agent processor and transmits the first control signal to outside.

8. The laser management server according to claim 1,
wherein the sending and receiving processor receives the query from a terminal connected via a network.

9. The laser management server according to claim 8,
wherein the query is received through an interactive operation screen on the terminal.

10. The laser management server according to claim 9,
wherein the first control signal is displayed on the interactive operation screen on the terminal.

11. A laser management method for a laser device, comprising:
a first step, to be performed by a sending and receiving processor, of receiving a query from outside;
a second step, to be performed by a query input processor, of decomposing the query and generating a first query item that requires external information and a second query item that does not require external information;
a third step, to be performed by an agent action processor, of receiving the first query item from the query input processor, acquiring the required external information from unstructured data including a manual and maintenance report of the laser device and structured data including operation data of the laser device and at least one of a prediction result of lifetime of a consumable of the laser device by a lifetime prediction model and a prediction result of laser performance of the laser device by a laser performance prediction model, and generating a first agent response that is a response to the first query item;
a fourth step, to be performed by an equipment agent processor, of receiving the second query item from the query input processor, receiving the first agent response from the agent action processor, and generating a query item prompt related to the second query item;
a fifth step, to be performed by a large language model processor, of receiving the query item prompt from the equipment agent processor, and generating a query item response that is a response to the query item prompt;
a sixth step, to be performed by the equipment agent processor, of receiving the query item response from the large language model processor, and generating a first control signal for controlling the laser device based on the first agent response and the query item response; and
a seventh step, to be performed by an equipment control processor, of receiving the first control signal from the equipment agent processor, and transmitting the first control signal to the laser device.

12. The laser management method according to claim 11, further comprising:
an eighth step, to be performed by the agent action processor, of acquiring the operation data of the laser device after transmitting the first control signal;
a ninth step, to be performed by the agent action processor, of generating a second agent response that is a response to the first query item;
a tenth step, to be performed by the equipment agent processor, of receiving the second agent response from the agent action processor, and determining whether or not the first control signal is required to be changed based on the second agent response;
an eleventh step, to be performed by the equipment agent processor, of generating, when it is determined that the first control signal is required to be changed, a second control signal for controlling the laser device based on the query item response and the second agent response; and
a twelfth step, to be performed by the equipment control processor, of receiving the second control signal from the equipment agent processor and transmitting the second control signal to the laser device.

13. The laser management method according to claim 11,
wherein, in the second step, the query input processor generates a sort prompt when performing language processing in the generation of the first query item and the second query item,
the large language model processor receives the sort prompt from the query input processor, and generates a sort response that is a response to the sort prompt, and
the query input processor receives the sort response from the large language model processor.

14. The laser management method according to claim 11,
wherein, in the third step, the agent action processor generates an unstructured data prompt when acquiring the unstructured data and generating the first agent response,
the large language model processor receives the unstructured data prompt from the agent action processor, and generates an unstructured data response that is a response to the unstructured data prompt, and
the agent action processor receives the unstructured data response from the large language model processor.

15. The laser management method according to claim 14,
wherein the unstructured data prompt includes the unstructured data.

16. The laser management method according to claim 11,
wherein the equipment agent processor transmits the first control signal to the sending and receiving processor.

17. The laser management method according to claim 11,
wherein, in the sixth step, the sending and receiving processor receives the first control signal from the equipment agent processor and transmits the first control signal to outside.

18. The laser management method according to claim 11,
wherein, in the first step, the sending and receiving processor receives the query from a terminal connected via a network.

19. The laser management method according to claim 18,
wherein the query is received through an interactive operation screen on the terminal.

20. The laser management method according to claim 19,
wherein the first control signal is displayed on the interactive operation screen on the terminal.
